(19) United States
(12) Patent Application Publication
(10) Pub. No.: US 2007/0004889 A1
(43) Pub. Date: Jan. 4, 2007

(54) Polymers based on n,n-diallylamine derivatives their production and use

(76) Inventors: Stefan Becker, Mannheim (DE); Lysander Chrisstoffels, Limburgerhof (DE)

Correspondence Address: CONNOLLY BOVE LODGE & HUTZ LLP, P.O. BOX 2207, WILMINGTON, DE, 19899-2207, US

(21) Appl. No.: 10/573,838

(22) PCT Filed: Sep. 18, 2004
(86) PCT No.: PCT/EP04/10495

§ 371 Date: Mar. 29, 2006

(30) Foreign Application Priority Data
Sep. 29, 2003 (DE) 10345602.3

(51) Int. Cl. C08F 120/00

(52) U.S. Cl. 526/303.1; 526/317.1; 526/319

(57) ABSTRACT

The present invention relates to processes for the preparation of novel polymers starting from the reaction of diallylamine or diallylamine derivatives with olefinically unsaturated compounds within the framework of a Michael addition and subsequent free-radical polymerization of the Michael adducts, if appropriate in the presence of further free-radically polymerizable compounds. The invention also provides the corresponding Michael adducts of diallylamine and its derivatives, and also the use of the novel polymers.

The present invention relates to novel homopolymers and copolymers based on N,N-diallylamine derivatives, to processes and intermediates for their preparation, and to processes for the preparation of the N,N-diallylamine derivatives which form the basis of these homopolymers and copolymers by Michael addition of optionally substituted diallylamine onto activated C═C double bonds.

Charged organic molecules play a large role in many areas of chemistry. A special place is occupied by the amphiphilic molecules which are used as surfactants in many areas of application.

Polyelectrolytes are macromolecular compounds which are made up completely or partially of ionic or ionizable monomer units. Their profile of properties is determined both by the chemical structure of the polymer chain and also by the nature, density and strength of the charge, and the localization of the ionic groups.

In numerous technical applications, water-soluble polymers are technology-determining as process auxiliaries. For example, polyquaternary polymers are used in a large number of industrial areas, such as papermaking, cosmetics, construction chemistry, detergent and cleaner formulation, textile processing, pharmacy and surface coating. Here, the polyelectrolytes act as polymeric surfactants, thickeners, solubilizers or dispersion stabilizers.

If functional groups with proton donors and acceptors are present in a polymer along-side one another and if the molecules can accordingly appear anionic or cationic depending on the pH, then polyelectrolytes of this type are called amphoteric polyelectrolates or polyampholytes. Polyampholytes can arise as polyacids or polybases depending on the pH of the medium.

Mumick et al. (Macromolecules 1994, 27, 323-331) describe the use of ampholytic polymers as auxiliaries for reducing flow resistance.

If the cationic charge is permanently present in the form of an aliphatic or aromatic ammonium, sulfonium or phosphonium function and is combined with the basic group in each monomer unit, then these zwitterionic compounds are referred to not as polyampholytes, but as polybetaines since such polymers exhibit different behavior in aqueous systems. A distinction is made between polysulfobetaines, polyphosphobetaines and polycarbobetaines depending on whether the anionic charge is carried by a sulfonate, phosphonate or carboxylate group.

Polycarbobetaines can in principle be obtained in two ways. Firstly by the synthesis of so-called precursor polymers and subsequent polymer-analogous reaction to give the corresponding polycarbobetaines [Al-Muallem et al., Polymer 43, 2002, 4285-4295], or by polymerization of betainic monomers which already carry a charge.

WO 00/14053 describes the synthesis of the polymers from a water-soluble hydrolysis-stable amphoteric monomer based on dimethylaminopropylmethacrylamide (DMAP-MA).

However, the free-radical polymerization of such monomers often leads onto oligomeric and nonuniform products, or the rate of polymerization is very low due to the low reactivity.

Polymers based on diallyl compounds are primarily polycarbobetaines starting from diallylammonium compounds with subsequent cyclizing polymerization [Favresse et al., Polymer 42 (2001) 2755-2766].

Depending on the pH, ampholytic polymers based on diallylamines and substituted diallylamines may be present in anionic, cationic or zwitterionic form.

Neutral and (zwitterionic) monomers based on diallylamine are known. For example Hodgkin et al. in J. Amer. Chem. Soc. 1980 (14) p. 211-233 describe a synthesis for diallylamine monomers via the reaction mechanism of the Mannich reaction. Furthermore, N-substituted diallylamine monomers are synthesized in a single-stage reaction by N-alkylation of diallylamine.

The same authors also describe the acid-catalyzed addition of 2-vinylpyridines onto diallylamine corresponding to the procedure by Reich et al. [JACS, 77 (1955) 4913-4915].

The formation of N-substituted 4-aminopyridine by reacting 4-chloropyridine with diallylamine with elimination of hydrogen chloride is described by Mathias et al. [U.S. Pat. No. 4,591,625].

N-Benzyl-substituted and N-heteroaromatically substituted diallylamines are likewise accessible via the Mannich reaction according to Hodgkin and Solomon [J. Macromol. Sci. Chem. A 10 (5), 893-922].

Al-Muallem et al. [Polymer 43 (2002) 1041-1050] describe the synthesis of N,N-diallyl-N-carboethoxymethylamine or -pentylamine by reacting diallylamine with chloroacetic acid or ethyl 1-chlorohexanoate with the addition of potassium carbonate.

Laschewsky et al. synthesize ethyl-2-(N,N-diallylamino)valerate by nucleophilic substitution.

All of these hitherto known syntheses of substituted diallylamine derivatives which comprise potentially anionic functions, in particular carboxyl groups, have the disadvantage that halogenated carboxylic esters are used during the nucleophilic substitution, and accordingly purification and hydrolysis steps have to be carried out until the acid function is obtained. This means simultaneously higher time and cost expenditure, and also lower yields.

Polymers based on diallylamine and substituted diallylamines are used, for example, for the preparation of flocculants and ion-exchange resins, and in fiber and paper technology.

Al-Muallem et al. describe the synthesis of a polypyrrolidine with a carboxylate-anion-functionalized side chain in Polymer 43 (2002), p. 4285. The complex synthesis leads from the free-radical polymerization of carboethoxymethyldiallylammonium chloride via a polymer-analogous hydrolysis, a dialysis and finally a deprotonation by means of NaOH to give the end product. The yield of product of value here is less than 50%. Hodgkin et al. indicate in J. Amer. Chem. Soc. 1980 (14) p. 211-233 that diallyl monomers with free acid functions are only very poorly polymerizable. The polymerization of 2-diallylaminobenzoic acid described therein does not lead to success.

Solomon et al. explain in J. Macromol. Sci.-Rev. Macromol. Chem., C15 (1976) p. 143-164, inter alia, that diallylamines are preferably polymerized in the form of their quaternary ammonium salts since the uncharged form is not “willingly” polymerizable under the conditions of the free-radical polymerization.

It was an object of the present invention to prepare homopolymers or copolymers accessible easily and in high yield from monomers based on diallylamine or derivatives thereof which are likewise accessible easily and in high yield, said polymers also carrying at least one functional group in addition to the optionally quaternized diallylamino group. This further functional group is preferably a proanionic, particularly preferably a carboxyl, group.

It has now surprisingly been found that polymers based on N,N-diallylamine are accessible easily and in high yields by, in a Michael addition, reacting N,N-diallylamine derivatives of the general formula I 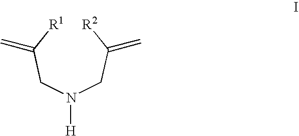
where
R¹, R², independently of one another, are hydrogen or C₁-C₄-alkyl, with compounds of the general formula II 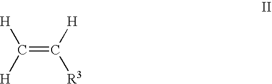
   where
R³ is COOR⁴, CN, CHO, SO₃H, PO(OH)₂ or CONR⁵R⁶, and
R⁴, R⁵ and R⁶, independently of one another, are hydrogen or C₁ to C₁₋₈-alkyl, and then free-radically polymerizing the Michael adducts, if appropriate in the presence of one or more free-radically copolymerizable monomers.

Preferred diallylamine derivatives of the formula I in which R¹, R², independently of one another, may, for example, be hydrogen, methyl, ethyl, n-propyl, 1-methylethyl, n-butyl, 1-methylpropyl, 2-methylpropyl or 1,1-dimethylethyl, are the compounds diallylamine, 2-methyldiallylamine or bis(2-methylallyl)amine, 2-ethyldiallylamine, bis(2-ethyl-allyl)amine, 2-isopropyldiallylamine, bis(2-isopropylallyl)amine, 2-tert-butyldiallylamine or bis(2-tert-butylallyl)amine. Particular preference is given to N,N-diallylamine.

Compounds of the general formula II are, for example, acrylic acid, acrylic esters, such as methyl acrylate, ethyl acrylate, propyl acrylate, butyl acrylate, t-butyl acrylate, isobutyl acrylate, 2-ethylhexyl acrylate and stearyl acrylate, and also acrylonitrile, acrolein, vinylsulfonic acid, vinylphosphonic acid, acrylamide, N-t-butylacrylamide and N-octylacrylamide.

A preferred compound of the general formula II is acrylic acid.

Accordingly, preference is given to the Michael addition of diallylamine and acrylic acid.

Monomers for the copolymerization with the reaction products according to the invention from compounds of the general formula I and compounds of the general formula II which may be mentioned are acrylic acid, methacrylic acid, maleic acid, fumaric acid, crotonic acid, itaconic acid, maleic anhydride and maleic half-esters, methyl acrylate, methyl methacrylate, ethyl acrylate, ethyl methacrylate, n-butyl acrylate, n-butyl methacrylate, t-butyl acrylate, t-butyl methacrylate, isobutyl acrylate, isobutyl methacrylate, 2-ethylhexyl acrylate, stearyl acrylate, stearyl methacrylate, N-t-butylacrylamide, N-octylacrylamide, 2-hydroxyethyl acrylate, hydroxypropyl acrylates, 2-hydroxyethyl methacrylate, hydroxypropyl methacrylates, alkylene glycol (meth)acrylates, styrene, unsaturated sulfonic acids, such as, for example, acrylamidopropanesulfonic acid, vinylpyrrolidone, vinylcaprolactam, vinyl ethers (e.g.: methyl, ethyl, butyl or dodecyl vinyl ethers), vinylformamide, vinylmethylacetamide, vinylamine, 1-vinylimidazole, 1-vinyl-2-methylimidazole, N,N-dimethylaminomethyl methacrylate and N-[3-(dimethylamino)propyl]methacrylamide, 3-methyl-1-vinylimidazolium chloride, 3-methyl-1-vinylimidazolium methylsulfate, N,N-dimethylaminoethyl methacrylate, N-[3-(dimethylamino)propyl]methacrylamide, methyl sulfate or diethyl sulfate. The monomers carrying amino groups may be present in quaternized form.

The present invention further provides a process for the preparation of the polymers starting from the compounds of the formulae I and II.

The process according to the invention involves the reaction of a compound of the general formula I with at least one compound of the general formula II in the sense of a Michael addition.

The preferred molar quantitative ratio of I to II is 1:1, although it is also possible to use an excess of one of the components. An example of an excess is 1:1.1 or 1.1:1.

Depending on the miscibility of the pure materials, the Michael addition can be carried out with or without solvents. Solvents which may be used are water, alcohols, such as, for example, methanol, ethanol, 1-propanol, 2-propanol, 1-butanol, 2-butanol, tert-butanol, ethers, such as, for example, diethyl ether, tert-butyl methyl ether, tetrahydro-furan, dioxane, aliphatic hydrocarbons, such as, for example, pentane, hexane, heptane, cyclopentane, cyclohexane, aromatic hydrocarbons, such as, for example, benzene, toluene, ethylbenzene, o-xylene, m-xylene, p-xylene, ketones, such as, for example, acetone, amides, such as, for example, N,N-dimethylformamide, N,N-dimethylacetamide, chlorinated hydrocarbons, such as, for example, dichloromethane, chloroform or 1,1,2,2-tetrachloroethane, sulfoxides, sulfones, such as, for example, dimethyl sulfoxide, diethyl sulfoxide or sulfolane.

A preferred embodiment is the reaction without solvents.

The products obtained from the Michael addition can be isolated in a manner known per se.

The Michael addition usually takes place at temperatures between −20 and +50° C., preferably between −10 and +30° C.

The invention further provides the products of the formula III obtained from this reaction 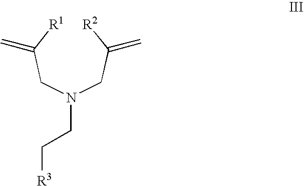
in which
R¹ and R², independently of one another, are hydrogen or C₁ to C₄-alkyl, R³ is COOR⁴, CN, CHO, SO₃H, PO(OH)₂ or CONR⁵R⁶, and
R⁴, R⁵ and R⁶, independently of one another, are hydrogen or C₁ to C₁₋₈-alkyl, where a quaternization of the nitrogen as a result of protonation may also be present.

The process according to the invention further involves the polymerization of the products of the formula III. The compounds of the general formula III according to the invention can be isolated or be used for the polymerization without further work-up.

The compounds of the general formula III according to the invention can be converted to homopolymers or, in the presence of one or more free-radically copolymerizable monomers, to copolymers.

The polymerization is a free-radical polymerization which is preferably carried out in solution.

Possible solvents are all solvents customary for polymerization reactions. A preferred solvent is water.

The free-radical polymerization is carried out in a manner known per se with exclusion of oxygen, for example by passing inert gas through and, if appropriate, under an inert-gas atmosphere, nitrogen preferably being used as the inert gas.

The initiators used for the free-radical polymerization may be water-soluble or water-insoluble initiators.

Customary initiators are peroxides, hydroperoxides, peroxodisulfates, percarbonates, peroxide esters, hydrogen peroxide and azo compounds.

Examples are hydrogen peroxide, dibenzoyl peroxide, dicyclohexyl peroxydicarbonate, dilauroyl peroxide, methyl ethyl ketone peroxide, di-tert-butyl hydroperoxide, acetyl acetone peroxide, tert-butyl hydroperoxide, cumene hydroperoxide, tert-butyl perneo-decanoate, tert-amyl perpivalate, tert-butyl perpivalate, tert-butyl perbenzoate, lithium, sodium, potassium and ammonium peroxodisulfate. Initiators which can be used are also water-soluble azo compounds, such as, for example, azobisisobutyronitrile, 2,2′-azobis[2-(5-methyl-2-imidazolin-2-yl)propane] dihydrochloride, 2,2′-azobis[2-(2-imidazolin-2-yl)propane] dihydrochloride, 2,2′-azobis[2-(2-imidazolin-2-yl)propane disulfate dihydrate, 2,2′-azobis(2-methylpropionamide) dihydrochloride, 2,2′-azobis[2-(3,4,5,6-tetrahydropyrimidin-2-yl)propane] dihydrochloride, 2,2′-azobis[2-(2-imidazolin-2-yl)propane], 4,4′-azobis(4-cyanovaleric acid), 1,1′-azobis(cyclohexanecarbonitrile), 2,2′-azobis(isobutyroamidine) dihydrochloride, 2,2′-azobis[N-(2-carboxyethyl)-2-methylpropionamidine] tetrahydrate, 2,2′-azobis{2-[1-(2-hydroxyethyl)-2-imidazolin-2-yl]propane} dihydrochloride, 2,2′-azobis{2-methyl-N-[1,1-bis(hydroxymethyl)-2-hydroxyethyl]propionamide, 2,2′-azobis{2-methyl-N-[2-(1-hydroxybutyl)]propionamide}, 2,2′-azobis[2-methyl-N-(2-hydroxyethyl)propionamide] and azo compounds which are soluble in organiic solvents, such as, for example, 2,2′-azobis(4-methoxy-2,4-dimethylvaleronitrile), 2,2′-azobis(2,4-dimethylvaleronitrile), di-methyl 2,2′-azobis(2-methylpropionate), 2,2′-azobis(2-methylbutyronitrile), 1,1′-azobis(cyclohexane-1-carbonitrile), 2,2′-azobis[N-(2-propenyl)-2-methylpropionamide], 1-[(cyano-1-methylethyl)azo]formamide, 2,2′-azobis(N-butyl-2-methylpropionamide), 2,2′-azobis(N-cyclohexyl-2-methylpropionamide).

The initiators can be used on their own or in the form of mixtures. Examples of such mixtures are binary mixtures, such as, for example, mixtures of hydrogen peroxide and sodium peroxodisulfate.

Water-soluble initiators are preferably used for the polymerization in aqueous medium.

Furthermore, redox initiator systems may be used as polymerization initiators. Such redox initiator systems comprise at least one peroxide-containing compound in combination with a redox coinitiator, such as, for example, reducing sulfur compounds, such as bisulfites, sulfites, thiosulfates, dithionites and tetrathionates of alkali metals and ammonium compounds.

For example, it is possible to use combinations of peroxodisulfates with alkali metal or ammonium hydrogensulfites, e.g. ammonium peroxodisulfate and ammonium disulfite. The quantitative ratios of peroxide-containing compound to redox coinitiator are in the range from 30:1 to 0.05:1.

In combination with the initiators or the redox initiator systems, transition metal catalysts can additionally be used, for example salts of iron, cobalt, nickel, copper, vanadium and manganese.

Suitable salts are, for example, iron(II) sulfate, cobalt(II) chloride, nickel(II) sulfate, or copper(I) chloride.

Based on the monomers, the reducing transition metal salt is usually used in a concentration in the range from 0.1 ppm to about 1000 ppm. It is thus possible to use combinations of hydrogen peroxide with iron(II) salts, such as, for example, 0.5 to 30% of hydrogen peroxide and 0.1 to 500 ppm of Mohr's salt.

In the case of polymerization in organic solvents, the abovementioned initiators can be used in combination with redox coinitiators and/or transition metal catalysts, for example benzoin, dimethylaniline, ascorbic acid, and organically soluble complexes of heavy metals, such as copper, cobalt, iron, manganese, nickel and chromium.

The amounts of redox coinitiators or transition metal catalysts customarily used are approximately 0.1 to about 1000 ppm, based on the amounts of monomers used.

In a preferred embodiment, water-soluble azo initiators, hydrogen peroxide, sodium persulfate, potassium persulfate or ammonium persulfate are used.

Particularly preferred initiators are water-soluble azo initiators, very particular preference being given to 2,2′-azobis[2-(2-imidazolin-2-yl)propane] dihydrochloride (trade name: VA-044).

The initiator amounts are generally between 0.5 and 10% by weight, based on the total mass of monomer. Preferred amounts are 1 to 6% by weight, particular preference being given to 2 to 4% by weight.

In the case of the copolymerization of compounds of the formula III with one or more free-radically polymerizable monomers, the molar fraction of compound III, based on the total amount of monomers, is in the range from 5 to 95 mol %, preferably in the range from 20 to 80 mol %, particularly preferably in the range from 45 to 55 mol %.

The polymerization can be carried out in a temperature range between 30 and 90° C., preferably between 40 and 70° C., very particularly preferably between 55 and 65° C.

The homopolymerization of monomers of the general formula III can be carried out with or without the addition of acid. In the absence of hydrolysis-sensitive substituents, it is preferably carried out in the presence of acids.

Suitable acids are hydrochloric acid, sulfuric acid, phosphoric acid, nitric acid, perchloric acid, methanesulfonic acid, p-toluenesulfonic acid, benzenesulfonic acid, trifluoroacetic acid, trifluoromethanesulfonic acid, formic acid, acetic acid, chloroacetic acid, dichloroacetic acid and trichloroacetic acid.

Hydrochloric acid, sulfuric acid and phosphoric acid are particularly suitable, and hydrochloric acid is very particularly suitable.

The homopolymerization of monomers of the general formula III in aqueous solution can preferably be carried out at acid concentrations in the range from 0 to 70 mol %. Particular preference is given to molar concentrations greater than 5 mol %, very particularly preferably greater than 30 mol %.

The copolymerization of monomers of the general formula III with monomers accessible to the hydrolysis, such as, for example, vinylformamide, is advantageously carried out in buffered aqueous solution.

The sum of the concentrations of the monomers in solution is between 15 and 85%, preferably between 25 and 75%, particularly preferably between 40 and 60%.

The properties, such as, for example, the molecular weight (M_{w}, Mₙ) of the polymers according to the invention depend on the chosen reaction conditions. For example, parameters which influence the reaction conditions are amount of initiator, type of initiator, course of the initiator addition, use of acid, type and amount of acid, solids content of the polymerization solution, temperature, reaction time, afterpolymerization with repeated initiator addition or period of afterpolymerization.

Depending on the reaction conditions chosen, the yields are between 40 and 95%. The molecular weights M_{w} are in the range between 10 000 and 300 000, in particular between 30 000 and 200 000.

Thus, for example, in the case of the preparation of poly(N,N-diallyl-3-aminopropionic acid) in hydrochloric acid medium with a solids content (total concentration of the monomers) of 50% and initiator concentrations of 3%, yields of 90% are achieved.

The solutions of the polymers according to the invention exhibit betainic behavior.

The polymers according to the invention can be used in diverse ways, for example in cosmetic and pharmaceutical compositions, foods, surfactants and cleaning compositions. The polymers according to the invention can be used in the petroleum industry, pulp processing, paint manufacture and textile industry.

The invention is illustrated in more detail by reference to the examples below, without limiting it to them:

### EXAMPLE 1

### N,N-Diallyl-3-aminopropionic acid

250 g of diallylamine were stirred at 0° C. under a nitrogen atmosphere. 185.5 g of acrylic acid (molar ratio 1:1) were added dropwise over two hours. The mixture was heated to 40° C. and stirred for a further four hours.

This gives, as reaction product, a brown, viscous liquid in quantitative yield. The pH of a 1% strength (mol %) aqueous solution is about 5.8.

Structure elucidation by means of NMR spectroscopy:

TABLE 1
¹H NMR (500 MHz, solvent CDCl₃):

| | |
|---|---|
| δ = 2.55 | t; 2H, N—CH₂—CH₂—COO |
| δ = 2.90 | t; 2H, N—CH₂—CH₂—COO |
| δ = 3.35 | d; 4H, ═CH—CH₂—N—CH₂—CH═ |
| δ = 5.26-5.38 | dd; 4H, CH₂═CH—CH₂—N—CH₂—CH═CH₂ |
| δ = 5.83-5.95 | m; 2H, CH₂═CH—CH₂—N—CH₂—CH═CH₂ |

¹³C NMR (500 MHz, solvent D₂O):
δ = 34, 52.5, 58, 129, 130 and 181 ppm.

### EXAMPLE 2

### Poly(N,N-diallyl-3-aminopropionic acid)

A monomer solution comprising 200 g of N,N-diallyl-3-aminopropionic acid, 67.5 g of 32% strength hydrochloric acid and 32.5 g of water was heated to 60° C. under a nitrogen atmosphere. Thereafter, addition of 10% of an 8% strength aqueous initiator solution of VA-044 (2,2′-azobis[2-(2-imidazolin-2-yl)propane] dihydrochloride) caused the polymerization to start (the total amount of initiator is 4% by weight, based on the total amount of monomer). A further 60% of initiator solution were added dropwise over 3 hours. After a further 2 hours with stirring, the remaining initiator solution was added over the course of an hour, finally the temperature was increased to 80° C. and the mixture was stirred for a further 3 hours. This gave the polymer in a yield of 93%.

The yield of poly(N,N-diallyl-3-aminopropionic acid) as a function of the acid concentration:

The polymers specified in table 2 were prepared essentially analogously to the reaction described in example 2, with the amount of acid being varied. Further reaction conditions:

The concentration of the acid is based on the amount of monomer.

Weight fraction of all monomers 50%, weight fraction of catalyst VA-044 4%, after-polymerization time 1 h, temperature 60° C., 10% by volume of the initiator solution added at the start of the reaction.

TABLE 2

| Concentration of acid | Yield of polymer |
|---|---|
| [mol %] | [%] |
| 0 | 70 |
| 10 | 85 |
| 20 | 88 |
| 30 | 86 |
| 50 | 90 |

Yield and molecular weight M_{w} of poly(N,N-diallyl-3-aminopropionic acid) as a function of the solids content of the monomer solution (% by weight)

The polymers given in table 3 were prepared essentially analogously to the reaction described in example 2 with the initial amount of monomer introduced being varied. Further reaction conditions:

After-polymerization time 1 h, temperature 60° C., 10% by volume of the initiator solution added at the start of the reaction, hydrochloric acid, acid concentration 50% based on amount of monomer, weight fraction of catalyst VA-044 2%.

TABLE 3

| Solids content of the monomer | | |
|---|---|---|
| solution | | Molecular weight |
| [% by weight] | Yield [%] | M_{W} |
| 25 | 65 | 43000 |
| 50 | 80 | 166000 |
| 75 | 60 | 121000 |

The yield and the molecular weight M_{w} of poly(N,N-diallyl-3-aminopropionic acid) as a function of the reaction temperature

The polymers given in table 4 were prepared essentially analogously to the reaction described in example 2, with the temperature being varied. Further reaction conditions: Weight fraction of all monomers 50%, weight fraction of catalyst VA-044 2%, after-polymerization time 1 h, 25% by volume of the initiator solution added at the start of the reaction, hydrochloric acid, acid concentration 50% based on the amount of monomer.

TABLE 4

| Temperature | Yield of polymer | Molecular weight |
|---|---|---|
| [° C.] | [%] | M_{w} |
| 55 | 63 | not determined |
| 60 | 75 | 147000 |
| 65 | 70 | 110000 |

The yield of poly(N,N-diallyl-3-aminopropionic acid) as a function of the amount of initiator (% by weight based on monomer)

The polymers given in table 5 were prepared essentially analogously to the reaction described in example 2, with the amount of initiator being varied. Further reaction conditions:

Weight fraction of all monomers 50%, after-polymerization time 1 h, temperature 60° C., 10% by volume of the initiator solution added at the start of the reaciton, hydrochloric acid, acid concentration 50% based on the amount of monomer.

TABLE 5

| Amount of initiator | Yield of polymer |
|---|---|
| [% by weight] | [%] |
| 2 | 80 |
| 3 | 90 |
| 4 | 90 |

Yields and molecular weights M_{w} of poly(N,N-diallyl-3-aminopropionic acid) as a function of various polymerization conditions

The polymers as given in table 6 were prepared essentially analogously to the reaction described in example 2, with the temperature and the initiator addition being varied. Further reaction conditions:

Weight fraction of the monomers 50% weight fraction of catalyst VA-044 2%, after-polymerization time 1 h,

Amount of acid based on amount of monomer 50%,

TABLE 6

| | | | without | hydrochloric | sulfuric | phosphoric |
|---|---|---|---|---|---|---|
| | Temperature | | acid | acid | acid | acid |
| 10% by volume | 60 | Yield [%] | 70 | 80 | 63 | 75 |
| of initiator | | Molecular weight M_{w} | 72000 | 166000 | 196000 | 133000 |
| at the start | 65 | Yield [%] | | 80 | 59 | 75 |
| | | Molecular weight M_{w} | | 116000 | 115000 | 125000 |
| 25% by volume | 60 | Yield [%] | | 75 | 43 | 69 |
| of initator | | Molecular weight M_{w} | | 147000 | 104000 | 96000 |
| at the start | 65 | Yield [%] | | 70 | 43 | 71 |
| | | Molecular weight M_{w} | | 110000 | 117000 | 116000 |

### EXAMPLE 4

### Poly(N,N-diallyl-3-aminopropionic acid-co-acrylamide)

A combined 50% strength aqueous solution of 169 g of N,N-diallyl-3-aminopropionic acid and 71 g of acrylamide (molar ratio 1:1) and a 4% strength, based on the amount of monomer, aqueous initiator solution of VA-044 (9.6 g dissolved in 480 ml of water) were each prepared in a dropping funnel. 20% of the monomer solution were added dropwise to the reaction vessel and heated to 60° C. By adding 20% of the initiator solution, the reaction was started. The remaining monomer solution was then added dropwise over the course of four hours, and the remaining initiator solution was added dropwise over the course of five hours. The reaction mixture was then stirred further for one hour at 80° C. This gave a slightly yellowish solution with a polymer yield of 85%.

Yields during the preparation of poly(N,N-diallyl-3-aminopropionic acid-co-acrylamide) under various reaction conditions

The polymers given in table 7 were prepared essentially analogously to the reaction described in example 4, the individual reaction conditions being given in table 6.

DPA: N,N-Diallyl-3-aminopropionic acid

AAM: Acrylamide

TABLE 7

| Reaction condition | | | | | |
|---|---|---|---|---|---|
| DPA:AAM monomer ratio | 1:1 | 1:1 | 1:2 | 1:1 | 1:1 |
| [ratio by weight] | | | | | |
| After-polymerization | 1 | 1 | 1 | 1 | 1 |
| time [hours] | | | | | |
| Amount of initiator | 2 | 2 | 2 | 2 | 4 |
| [% by weight] | | | | | |
| Reaction time [hours] | 6 | 6 | 6 | 6 | 6 |
| Solids content [% by | 25 | 25 | 25 | 25 | 25 |
| weight] | | | | | |
| Temperature [° C.] | 60 | 60 | 60 | 60 | 60 |
| Amount of acid [mol % | — | 5 | — | — | — |
| with respect to monomer] | | | | | |
| Yield [%] | 73 | 73 | 86 | 78 | 85 |

### EXAMPLE 6

### Poly(N,N-diallyl-3-aminopropionic acid-co-vinylformamide)

A combined 25% strength aqueous solution of N,N-diallyl-3-aminopropionic acid and vinylformamide (molar ratio 1:1) and a 4% strength by weight, based on the amount of monomer, aqueous initiator solution of VA-044 were each prepared in a dropping funnel. 20% of the monomer solution were added dropwise to the reaction vessel and heated to 60° C. 4.8 g of NaH₂PO₄.2H₂O were added as buffer. By adding 20% of the initiator solution, the reaction was started. The remaining monomer solution was then added dropwise over the course of four hours and the remaining initiator solution was added dropwise over the course of five hours. The reaction mixture was then stirred further for one hour at 80° C.

The polymer yield was 94%.

Yields during the preparation of poly(N,N-diallyl-3-aminopropionic acid-co-vinylformamide) under various reaction conditions

The polymers given in table 8 were prepared essentially analogously to the reaction described in example 4, the individual reaction conditions being given in table 8.

VFA: Vinylformamide

TABLE 8

| Reaction conditions | | | |
|---|---|---|---|
| DPA:VFA monomer ratio | 1:1 | 1:1 | 1:2 |
| [ratio by weight] | | | |
| After-polymerization | 1 | 1 | 1 |
| time [hours] | | | |
| Amount of initiator | 4 | 2 | 2 |
| [% by weight] | | | |
| Reaction time [hours] | 6 | 6 | 6 |
| Solids content | 25 | 25 | 25 |
| [% by weight] | | | |
| Temperature [° C.] | 60 | 60 | 60 |
| Yield [%] | 94 | 90 | 92 |

1. A process for the preparation of polymers, which comprises reacting N,N-diallylamine derivatives of the general formula I 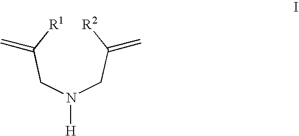
where R¹, R², independently of one another, are hydrogen or C₁-C₄-alkyl,
with compounds of the general formula II 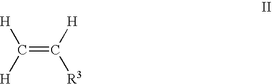
where R³ is COOR⁴, CN, CHO, SO₃H, PO(OH)₂ or CONR⁵R⁶,
R⁴, R⁵, R⁶, independently of one another, are hydrogen or C₁ to C₁₈-alkyl to form a Michael product, and polymerizing the Michael product in the presence of one or more free-radically copolymerizable monomers.

2. A process according to claim 1, where R¹ and R² are hydrogen.

3. A process according to claim 1, where R³ is COOH.

4. A process according to, claim 1 wherein the polymerization is carried out in the presence of one or more monomers selected from the group consisting of acrylic acid, methacrylic acid, maleic acid, fumaric acid, crotonic acid, itaconic acid, maleic anhydride and maleic half-esters, methyl acrylate, methyl methacrylate, ethyl acrylate, ethyl methacrylate, n-butyl acrylate, n-butyl methacrylate, t-butyl acrylate, t-butyl methacrylate, isobutyl acrylate, isobutyl methacrylate, 2-ethylhexyl acrylate, stearyl acrylate, stearyl methacrylate, acrylamide, N-t-butylacrylamide, N-octylacrylamide, 2-hydroxyethyl acrylate, hydroxypropyl acrylates, 2-hydroxyethyl methacrylate, hydroxypropyl methacrylates, alkylene glycol (meth)acrylates, styrene, unsaturated sulfonic acids, such as, for example, acrylamidopropanesulfonic acid, vinylpyrrolidone, vinylcaprolactam, vinyl ethers (e.g.: methyl, ethyl, butyl or dodecyl vinyl ethers), vinylformamide, vinylmethylacetamide, vinylamine, 1-vinylimidazole, 1-vinyl-2-methylimidazole, N,N-dimethylaminomethyl methacrylate and N-[3-(dimethylamino)propyl]methacrylamide, 3-methyl-1-vinylimidazolium chloride, 3-methyl-1-vinylimidazolium methylsulfate, N,N-dimethylaminoethyl methacrylate, N-[3-(dimethylamino)propyl]methacrylamide quaternized with methyl chloride, methyl sulfate and diethyl sulfate.

5. A process according to, claim 1 wherein the polymerization is conducted in the presence of an acid selected from the group consisting of hydrochloric acid, sulfuric acid, phosphoric acid and nitric acid.

6. A process according to claim 1, wherein the reaction temperature is between 30 and 90° C.

7. A process according to 6 claim 1, wherein the reaction temperature is between 40 and 70° C.

8. Polymers obtainable by a process according to claim 1.

9. N,N-Diallylamine derivatives of the general formula III 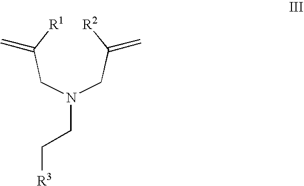
in which R¹, R², independently of one another, are hydrogen or C₁ to C₄-alkyl,
R³ is COOR⁴, CN, CHO, SO₃H, PO(OH)₂ or CONR⁵R⁶, and
R⁴, R⁵, R⁶, independently of one another, are hydrogen or C₁ to C₁₈-alkyl,
where a quaternization of the nitrogen as a result of protonation may also be present.

10. N,N-Diallylamine derivatives according to claim 9, where R¹ and R² are hydrogen.

11. N,N-Diallylamine derivatives according to claim 9, where R³ is COOH.

12. A process for the preparation of substituted N,N diallylamine derivatives of the general formula III according to claim 9, which comprises reacting N,N-diallylamine derivatives of general formula I 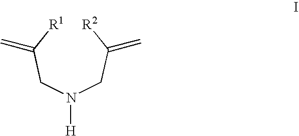
where R¹, R², independently of one another, are hydrogen or C₁-C₄-alkyl and compounds of general formula II 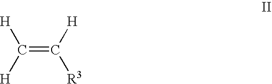
where R³ is COOR⁴, CN, CHO, SO₃H, PO(OH)₂ or CONR⁵R⁶ and R⁴, R⁵, R⁶, independently of one another, are hydrogen or C₁ to C₁₈-alkyl.

13. A process according to claim 12, wherein the reaction of the derivatives of general formula I and the compounds of general formula II is conducted in the absence of a reaction solvent.

14. Use of the polymers according to claim 8 for the preparation of cosmetic and pharmaceutical compositions.

15. Use of the polymers according to claim 8 for the preparation of fixatives and flocculants.

16. Use of the polymers according to claim 8 for the preparation of detergents and cleaners.

17. Use of the polymers according to claim 8 in polymer dispersions.

18. A process according to claim 2, where R³ is COOH.

19. N,N-Diallylamine derivatives according to claim 10, where R³ is COOH.

20. A process according to claim 11, wherein the reaction of the derivatives of general formula I and the compounds of general formula II is conducted in the absence of a reaction solvent.
